(19) United States
(12) Patent Application Publication
(10) Pub. No.: US 2026/0291185 A1
(43) Pub. Date: Sep. 24, 2026

(54) SPARK PLUG

(71) Applicant: Niterra Co., Ltd., Nagoya-shi (JP)

(72) Inventor: Masahiro NISHIDA, Nagoya-shi (JP)

(73) Assignee: Niterra Co., Ltd., Nagoya-shi (JP)

(21) Appl. No.: 19/453,376

(22) Filed: Jan. 20, 2026

(30) Foreign Application Priority Data
Mar. 18, 2025 (JP) 2025-043159

(51) Int. Cl. H01T 13/32; H01T 13/39

(52) U.S. Cl. CPC H01T 13/32; H01T 13/39

(57) ABSTRACT

A spark plug includes an insulator extending along an axial line, a center electrode held within the insulator, a metal shell placed on the insulator, and a ground electrode including an end portion located on a distal side relative to the center electrode, the ground electrode being connected to the metal shell. The ground electrode includes a parent material, a first core material provided inside the parent material, and a second core material provided inside the first core material and being made of a different material from the first core material. The end portion includes a melt-formed portion in which the parent material is melted and that contains precious metal, and a discharge surface forming a surface of the melt-formed portion and facing the center electrode in a direction of the axial line. The melt-formed portion is in contact with the first core material and the second core material.

### FIELD OF THE INVENTION

The present invention relates to a spark plug including a ground electrode in which a core material is provided inside a parent material.

### BACKGROUND OF THE INVENTION

A spark plug in which a core material is provided inside a parent material of a ground electrode is disclosed in Japanese Unexamined Patent Application Publication No. 2005-135783 as a related art. In the spark plug disclosed in Japanese Unexamined Patent Application Publication No. 2005-135783, a tip containing precious metal is provided at an end portion of the ground electrode. For prevention of overheating at the end portion due to spark discharge between the end portion of the ground electrode and a center electrode, the tip is embedded in the parent material in such a manner as to be in contact with the core material.

There is a difference between the coefficient of thermal expansion of each of the parent material and the coefficient of thermal expansion of the tip. Therefore, in the related art, expansion and/or contraction due to temperature change may produce a gap between the parent material or the core material and the tip. In that event, the thermal conductivity from the tip to the parent material or the core material decreases, which may lead to overheating at the end portion of the ground electrode.

The object of the present invention is to solve the above problem and to provide a spark plug that is less likely to cause overheating at an end portion of a ground electrode.

### SUMMARY OF THE INVENTION

According to a first aspect to achieve the above object, a spark plug includes an insulator having an axial hole extending along an axial line, a center electrode provided at a distal-side position inside the axial hole of the insulator, a metal shell provided on an outer periphery of the insulator, and a ground electrode including an end portion located on a distal side relative to the center electrode, the ground electrode being connected to the metal shell. The ground electrode includes a parent material, a first core material provided inside the parent material, and a second core material provided inside the first core material and being made of a different material from the first core material. The end portion includes a melt-formed portion in which part of the parent material is melted and that contains precious metal, and a discharge surface forming a surface of the melt-formed portion and facing the center electrode in a direction of the axial line. The melt-formed portion is in contact with the first core material and the second core material.

According to a second aspect, in the first aspect, the melt-formed portion is in contact with the parent material, the first core material, the second core material, and the first core material in order in a direction away from the center electrode with respect to the axial line.

According to a third aspect, in the first or second aspect, in a section of the end portion that is taken perpendicularly to a direction in which the ground electrode extends, a distance between a closer one of surfaces of the parent material with respect to the center electrode and a center of gravity of the first core material is shorter than a distance between a farther one of the surfaces of the parent material with respect to the center electrode and the center of gravity of the first core material.

According to the present invention, the melt-formed portion formed by melting part of the parent material is in contact with the first core material and the second core material at the end portion of the ground electrode. The difference between the coefficient of thermal expansion of each of the parent material and the core material and the coefficient of thermal expansion of the melt-formed portion is smaller than the difference between the coefficient of thermal expansion of each of the parent material and the core material and the coefficient of thermal expansion of the tip. Accordingly, a gap is less likely to be produced between the melt-formed portion and each of the parent material, the first core material, and the second core material. Such a configuration ensures the thermal conductivity between the melt-formed portion and each of the parent material, the first core material, and the second core material. Therefore, overheating at the end portion of the ground electrode is less likely to occur.

### BRIEF DESCRIPTION OF THE DRAWINGS

FIG. 1 illustrates a spark plug according to a first embodiment, with one side thereof illustrated in sectional view.

FIG. 2 is a sectional view of a ground electrode.

FIG. 3 is a sectional view of a ground electrode included in a spark plug according to a second embodiment.

FIG. 4 is a sectional view of the ground electrode, taken along line IV-IV given in FIG. 3.

### DETAILED DESCRIPTION OF THE INVENTION

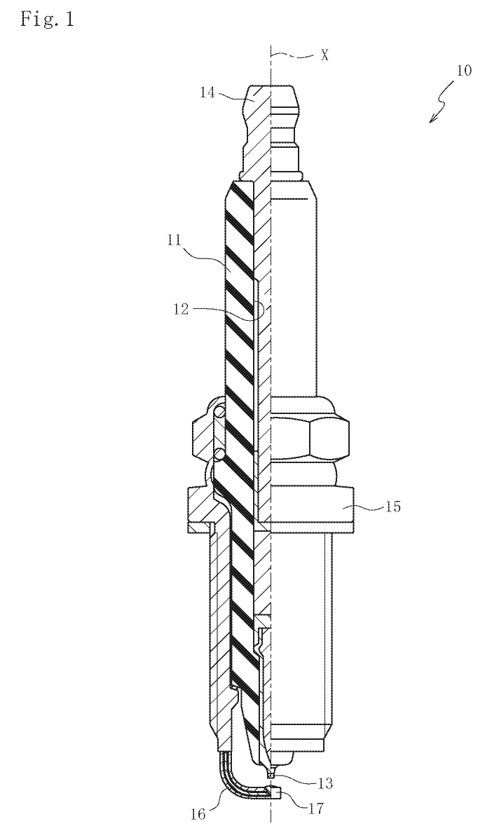

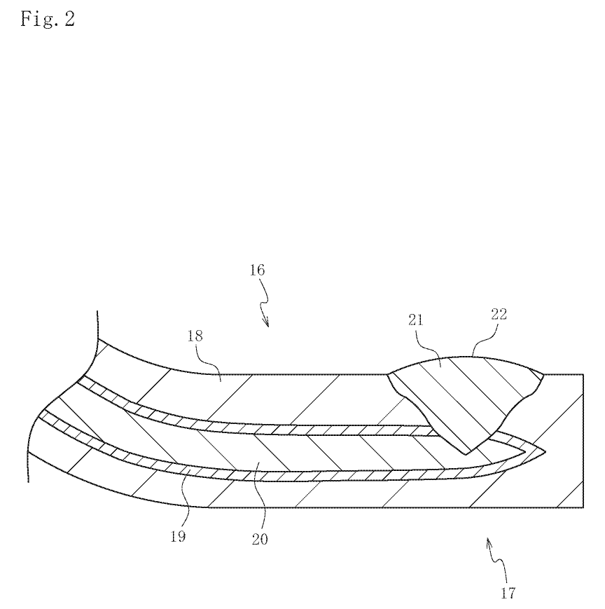

Preferred embodiments of the present invention will now be described with reference to the accompanying drawings. FIG. 1 illustrates a spark plug 10 according to a first embodiment, with one side thereof relative to an axial line X illustrated in sectional view. The lower side of the page in FIG. 1 is referred to as the distal side of the spark plug 10, and the upper side of the page is referred to as the proximal side of the spark plug 10 (the same applies to FIGS. 2-4). As illustrated in FIG. 1, the spark plug 10 includes an insulator 11, a center electrode 13, a metal shell 15, and a ground electrode 16.

The insulator 11 is a substantially circular cylindrical member made of ceramic, such as alumina, which is excellent in mechanical characteristics and in insulation under high temperature. The insulator 11 has an axial hole 12, which extends along the axial line X.

The center electrode 13 is a bar-type conductor provided at a distal-side position inside the axial hole 12 of the insulator 11. The center electrode 13 projects from the insulator 11 toward the distal side. The center electrode 13 is electrically connected to a metal terminal 14 inside the axial hole 12.

The metal terminal 14 is a bar-type member to which an ignition system (not illustrated) is to be connected. The metal terminal 14 is made of an electrically conductive metallic material (such as low-carbon steel or the like). The metal terminal 14 projects from the insulator 11 toward the proximal side. The metal terminal 14 is fixed to the insulator 11 with a distal portion thereof being placed inside the axial hole 12.

The metal shell 15 is fixed to the outer periphery of the insulator 11. The metal shell 15 is a substantially circular cylindrical member made of an electrically conductive metallic material (such as low-carbon steel or the like). The metal shell 15 is to be fixed to a screw (not illustrated) provided inside a plug hole of an engine (cylinder head). The ground electrode 16 is connected to the metal shell 15.

The ground electrode 16 is a bar-type conductor including an end portion 17, which is located on the distal side relative to the center electrode 13. A spark gap is provided between the end portion 17 and the center electrode 13. In the present embodiment, the ground electrode 16 extends from the metal shell 15 and is curved to the end portion 17. Such a shape of the ground electrode 16 is not limiting.

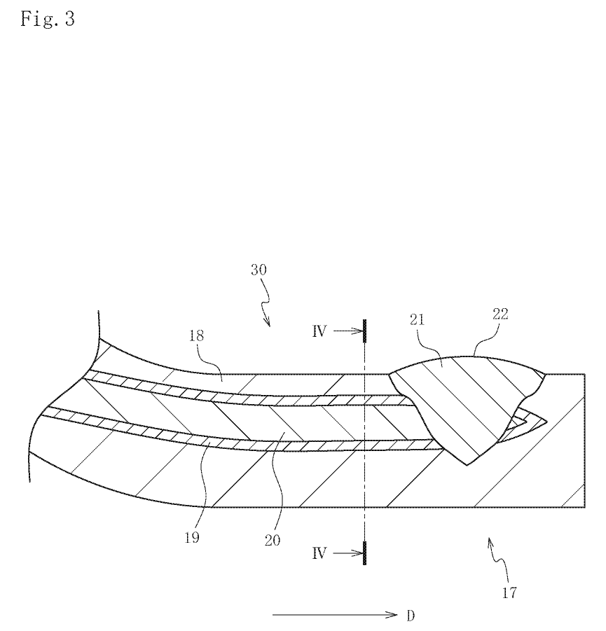

FIG. 2 is a sectional view of the ground electrode 16. FIG. 2 illustrates part of the ground electrode 16 that is around the end portion 17, with part near the metal shell 15 not illustrated (the same applies to FIG. 3). The ground electrode 16 includes a parent material 18; a first core material 19, which is provided inside the parent material 18; and a second core material 20, which is provided inside the first core material 19. The first core material 19 and the second core material 20 each extend from the end portion 17 of the ground electrode 16 to a part where the ground electrode 16 and the metal shell 15 (see FIG. 1) are joined to each other. The second core material 20 is made of a different material from the first core material 19.

An exemplary material for the parent material 18 is a nickel alloy such as inconel 600 (a registered trademark). An exemplary material for the first core material 19 is copper. An exemplary material for the second core material 20 is nickel. These materials for the parent material 18, the first core material 19, and the second core material 20 are only exemplary and are not limiting. The materials for the parent material 18, the first core material 19, and the second core material 20 are selected as appropriate such that the coefficients of thermal conductivity of the first core material 19 and the second core material 20 are higher than the coefficient of thermal conductivity of the parent material 18. For example, the materials are selected such that the coefficient of thermal conductivity of the first core material 19 is higher than the coefficient of thermal conductivity of the second core material 20, and the coefficient of thermal conductivity of the second core material 20 is higher than the coefficient of thermal conductivity of the parent material 18.

A melt-formed portion 21 has a chemical composition containing one of or two or more of precious metals such as Pt, Rh, Ir, and Ru. To provide satisfactory resistance to spark erosion, the melt-formed portion 21 may preferably have a chemical composition containing 20 wt% or more of precious metal. The ratio of precious metal in the melt-formed portion 21 is obtained through, for example, an analysis conducted with a scanning electron microscope including an energy-dispersive X-ray spectroscope (SEM-EDS).

The melt-formed portion 21 includes a discharge surface 22, which faces toward the proximal side. The discharge surface 22 faces the center electrode 13 (see FIG. 1) in the direction of the axial line X. Since the melt-formed portion 21 including the discharge surface 22 contains precious metal, the melt-formed portion 21 exhibits increased resistance to spark erosion. In the present embodiment, the melt-formed portion 21 has a spherical-crown-shaped portion bulging toward the proximal side, and the discharge surface 22 has a substantially circular shape.

The ground electrode 16 is manufactured as follows, for example. A disc-shaped member containing precious metal as a chief component is placed on a parent material 18, in which a first core material 19 and a second core material 20 are embedded. Subsequently, while the member is pressed against the parent material 18, an electric current is supplied between the member and the parent material 18, specifically, resistance welding is performed. Thus, the member is fixed to the parent material 18. Subsequently, laser beam welding is performed in which a laser beam is applied from a processing head to the member, whereby the member and part of the parent material 18 that is near the member are melted. Thus, a ground electrode 16 in which a melt-formed portion 21 containing precious metal is provided at an end portion 17 is obtained. In the present embodiment, the entirety of the member containing precious metal is melted into the melt-formed portion 21. Therefore, the precious metal is evenly distributed in the melt-formed portion 21.

The ratio of precious metal in the melt-formed portion 21 is set on the basis of the amount of precious metal to be contained in the member containing precious metal as a chief component, the size of the member, the amount of melting of the parent material 18, and/or the like. The shape and/or depth of the melt-formed portion 21 is set on the basis of the shape of the member, the shape of the part of the parent material 18 that is to be in contact with the member, the angle and/or range of laser-beam application, the distribution of the spatial intensity of the laser beam, the intensity of the beam, and/or the like.

The melt-formed portion 21 is in contact with the parent material 18, the first core material 19, and the second core material 20 in order in a direction away from the center electrode 13 (downward in FIG. 2) with respect to the axial line X (see FIG. 1). The first core material 19 and the second core material 20 are melted into the melt-formed portion 21. Therefore, chemical elements contained in the first core material 19 are present in a region where the melt-formed portion 21 and the first core material 19 are in contact with each other, and chemical elements contained in the second core material 20 are present in a region where the melt-formed portion 21 and the second core material 20 are in contact with each other.

In one example, the coefficient of thermal expansion of the first core material 19 is higher than the coefficient of thermal expansion of the second core material 20, the coefficient of thermal expansion of the second core material 20 is higher than the coefficient of thermal expansion of the parent material 18, and the coefficient of thermal expansion of the parent material 18 is higher than the coefficient of thermal expansion of the member containing precious metal as a chief component. The melt-formed portion 21 is formed by melting the member containing precious metal as a chief component, the parent material 18, the first core material 19, and the second core material 20. Therefore, the coefficient of thermal expansion of the melt-formed portion 21 is higher than the coefficient of thermal expansion of the member containing precious metal as a chief component.

The melt-formed portion 21 provided at the end portion 17 of the ground electrode 16 is in contact with the parent material 18, the first core material 19, and the second core material 20. Therefore, the heat generated at the end portion 17 is not only transmitted through the parent material 18 but is also transmitted from the first core material 19 and the second core material 20 through the metal shell 15 (see FIG. 1) to the engine. The coefficients of thermal conductivity of the first core material 19 and the second core material 20 are higher than the coefficient of thermal conductivity of the parent material 18. Therefore, the thermal conductivity of the ground electrode 16 is higher than in a case where the melt- formed portion 21 is in contact with neither of the first core material 19 and the second core material 20. Accordingly, overheating at the end portion 17 of the ground electrode 16 is less likely to occur, which increases the resistance of the melt-formed portion 21 to erosion.

The difference between the coefficient of thermal expansion of each of the parent material 18, the first core material 19, and the second core material 20 and the coefficient of thermal expansion of the melt-formed portion 21 is smaller than the difference between the coefficient of thermal expansion of each of the parent material 18, the first core material 19, and the second core material 20 and the coefficient of thermal expansion of the member containing precious metal as a chief component (corresponding to the tip according to Japanese Unexamined Patent Application Publication No. 2005-135783). Accordingly, expansion and/or contraction due to temperature change is less likely to produce a gap between the melt-formed portion 21 and each of the parent material 18, the first core material 19, and the second core material 20. The less likeliness in the production of the gap ensures the thermal conductivity between the melt-formed portion 21 and each of the parent material 18, the first core material 19, and the second core material 20. Therefore, overheating at the end portion 17 of the ground electrode 16 is less likely to occur.

The difference between the coefficient of thermal expansion of the melt-formed portion 21 and the coefficient of thermal expansion of the second core material 20 is smaller than the difference between the coefficient of thermal expansion of the melt-formed portion 21 and the coefficient of thermal expansion of the first core material 19. Therefore, the melt-formed portion 21 being in contact with the second core material 20 increases the anti-peeling performance of the melt-formed portion 21 against expansion and/or contraction due to temperature change, compared with a case where the melt-formed portion 21 is not in contact with the second core material 20.

Referring to FIG. 3, a second embodiment will now be described. FIG. 3 is a sectional view of a ground electrode 30 included in a spark plug according to the second embodiment. The direction of arrow D given in FIG. 3 indicates a direction in which the ground electrode 30 extends. The ground electrode 30 is included in the spark plug 10 in replacement of the ground electrode 16 according to the first embodiment. In the second embodiment, elements that are the same as those described in the first embodiment are denoted by corresponding ones of the reference signs used in the first embodiment, and some redundant description in the following description is omitted.

The ground electrode 30 includes a parent material 18; a first core material 19, which is provided inside the parent material 18; and a second core material 20, which is provided inside the first core material 19. A melt-formed portion 21 is in contact with the parent material 18, the first core material 19, the second core material 20, the first core material 19, and the parent material 18 in order in a direction away from the center electrode 13 with respect to the axial line X (see FIG. 1). Since the melt-formed portion 21 is in contact with the first core material 19 twice, the area of contact between the melt-formed portion 21 and the first core material 19 is greater than in the case where the melt-formed portion 21 is in contact with the parent material 18, the first core material 19, and the second core material 20 in order in the direction away from the center electrode 13 with respect to the axial line X. Accordingly, the thermal conductivity between the first core material 19 and the melt-formed portion 21 increases. Therefore, overheating at the end portion 17 of the ground electrode 30 is much less likely to occur.

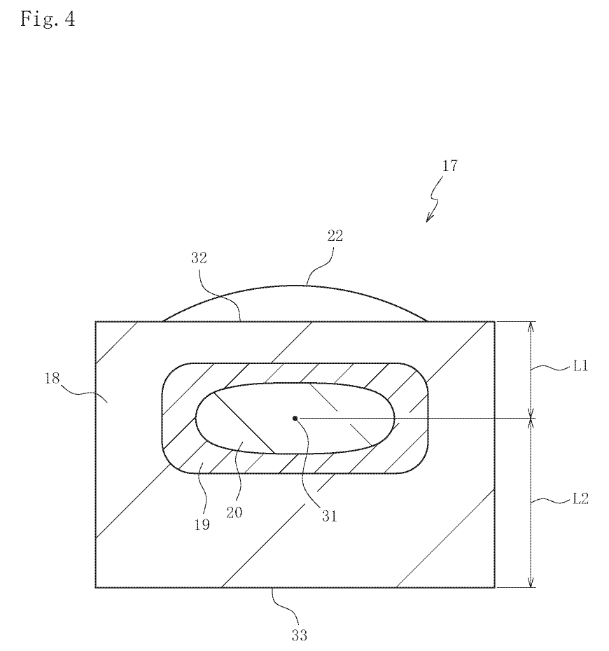

FIG. 4 is a sectional view of the end portion 17 of the ground electrode 30, taken along line IV-IV given in FIG. 3. Line IV-IV in FIG. 3 is a cutting line perpendicular to the direction in which the ground electrode 30 extends (the direction of arrow D in FIG. 3). The first core material 19 has a center of gravity 31, which is the geometric center of the external shape of the first core material 19 (the shape of the interface between the first core material 19 and the parent material 18).

Fire is generated by spark discharge between the end portion 17 of the ground electrode 30 and the center electrode 13 (see FIG. 1). Therefore, a surface 32, which is a closer one of the surfaces of the parent material 18 with respect to the center electrode 13, tends to be heated easier than a surface 33, which is a farther one of the surfaces of the parent material 18 with respect to the center electrode 13. In the end portion 17, a distance L1 between the closer surface 32 of the parent material 18 with respect to the center electrode 13 and the center of gravity 31 of the first core material 19 is shorter than a distance L2 between the farther surface 33 of the parent material 18 with respect to the center electrode 13 and the center of gravity 31 of the first core material 19 (L1 < L2). Therefore, the heat around the surface 32 of the parent material 18 is more easily transmitted to the metal shell 15 (see FIG. 1) than in a case of L1 ≥ L2. Accordingly, overheating at the end portion 17 is much less likely to occur.

Since the distance L1 is shorter than the distance L2 (L1 < L2) in the end portion 17, even if the melt-formed portion 21 is shallow, it is easier to provide the melt-formed portion 21 in contact with the first core material 19 and the second core material 20 than in the case of L1 ≥ L2. Since the melt-formed portion 21 can be provided in contact with the first core material 19 and the second core material 20 without increasing the output power in laser beam welding for forming the melt-formed portion 21, the energy consumption in laser beam welding for forming the melt-formed portion 21 is saved.

While the present invention has been described above on the basis of embodiments thereof, the present invention is not limited to the above embodiments in any way. It is easily understood that various improvements and modifications can be made within the scope of the present invention.

While the above embodiments relate to a case where the melt-formed portion 21 includes a spherical-crown-shaped portion bulging from the parent material 18 with a curved discharge surface 22, such an embodiment is not limiting. It is of course possible to make the discharge surface of the melt-formed portion flat in such a manner as to be substantially flush with the surface 32 of the parent material 18, or to make a recess in the discharge surface. Such a discharge surface may be formed as follows, for example: a recess is made in the surface 32 of the parent material 18, a member containing precious metal as a chief component is placed in the recess, and a laser beam is applied to the member.

While the above embodiments relate to a case where the boundary of the melt-formed portion 21 (the external shape of the melt-formed portion 21 at the surface 32 of the parent material 18) is circular, such an embodiment is not limiting. The shape of the boundary of the melt-formed portion may be set as appropriate. For example, it is of course possible to form a melt-formed portion having a polygonal shape, such as a rectangular shape. If a polygonal melt-formed portion is formed, the polygonal shape thereof typically have round corners.

While the above embodiments relate to a case where the entirety of the member containing precious metal is melted into the melt-formed portion 21, such an embodiment is not limiting. It is of course possible that a portion (residual portion) of the member containing precious metal as a chief component be left unmelted in laser beam welding. The residual portion may appear at the discharge surface 22 of the melt-formed portion 21 or may be embedded in the melt-formed portion 21. If the melt-formed portion 21 includes the residual portion as a portion of the member that is left unmelted, the amount of precious metal melted into the melt-formed portion 21 is smaller than in the case where the entirety of the member is melted. If the volume of the residual portion is made smaller than the volume of the melt-formed portion 21, the ratio of precious metal in the melt-formed portion 21 is increased to some extent. Therefore, the reduction in the resistance of the melt-formed portion 21 to spark erosion is suppressed.

While the above embodiments relate to a case where the ground electrode 16 or 30 is a curved bar-type member, such an embodiment is not limiting. It is of course possible to provide a spark gap between the center electrode 13 and an end portion of a linear ground electrode by extending the metal shell 15 in the axial direction such that the distal end of the metal shell 15 is located near the distal end of the center electrode 13, and connecting the linear ground electrode to the distal end of the metal shell 15.

While the above embodiments relate to a case where the end portion 17 has a rectangular shape in a section taken perpendicularly to the direction D in which the ground electrode 16 extends, such an embodiment is not limiting. The sectional shape of the end portion 17 may be set to any shape, such as a rounded rectangular shape having four round corners, an oval shape, or a semicircular shape.

While the second embodiment relates to a case where end portions of the first core material 19 and the second core material 20 project from the melt-formed portion 21 in the direction D in which the ground electrode 30 extends, such an embodiment is not limiting. It is of course possible to form the melt-formed portion 21 such that end portions of the first core material 19 and the second core material 20 overlap the melt-formed portion 21. Even in a case where end portions of the first core material 19 and the second core material 20 are located inside the melt-formed portion 21, the melt-formed portion 21 can be provided in contact with the parent material 18, the first core material 19, the second core material 20, and the first core material 19 in order in the direction away from the center electrode 13 with respect to the axial line X (see FIG. 1).

While the second embodiment relates to a case where the melt-formed portion 21 is in contact with the parent material 18, the first core material 19, the second core material 20, the first core material 19, and the parent material 18 in order in the direction away from the center electrode 13 with respect to the axial line X (see FIG. 1), such an embodiment is not limiting. It is of course possible that the bottom of the melt-formed portion 21 in the depth direction be located inside a second part of the first core material 19 by reducing the depth of the melt-formed portion 21. In such a case as well, the melt-formed portion 21 is in contact with the parent material 18, the first core material 19, the second core material 20, and the first core material 19 in order.

### DESCRIPTION OF REFERENCE NUMERALS

10 spark plug

11 insulator

12 axial hole

13 center electrode

15 metal shell

16,30 ground electrode

17 end portion

18 parent material

19 first core material

20 second core material

21 melt-formed portion

22 discharge surface

31 center of gravity

32,33 surface

L1,L2 distance

X axial line

What is claimed is:

1. A spark plug comprising:
an insulator having an axial hole extending along an axial line;
a center electrode provided at a distal-side position inside the axial hole of the insulator;
a metal shell provided on an outer periphery of the insulator; and
a ground electrode including an end portion located on a distal side relative to the center electrode, the ground electrode being connected to the metal shell,
wherein the ground electrode includes a parent material; a first core material provided inside the parent material; and a second core material provided inside the first core material and being made of a different material from the first core material,
wherein the end portion includes a melt-formed portion in which part of the parent material is melted and that contains precious metal; and a discharge surface forming a surface of the melt-formed portion and facing the center electrode in a direction of the axial line, and
wherein the melt-formed portion is in contact with the first core material and the second core material.

2. The spark plug according to claim 1,
wherein the melt-formed portion is in contact with the parent material, the first core material, the second core material, and the first core material in order in a direction away from the center electrode with respect to the axial line.

3. The spark plug according to claim 1,
wherein in a section of the end portion that is taken perpendicularly to a direction in which the ground electrode extends, a distance between a closer one of surfaces of the parent material with respect to the center electrode and a center of gravity of the first core material is shorter than a distance between a farther one of the surfaces of the parent material with respect to the center electrode and the center of gravity of the first core material.
